(19) United States
(12) Patent Application Publication
(10) Pub. No.: US 2019/0163872 A1
(43) Pub. Date: May 30, 2019

(54) COGNITIVE ACUPUNCTURE ASSISTANT FOR TREATMENT SUGGESTIONS

(71) Applicant: International Business Machines Corporation, Armonk, NY (US)

(72) Inventors: Anita Govindjee, Ithaca, NY (US); Su Liu, Austin, TX (US); Cheng Xu, Beijing (CN); Ju Ling Liu, Beijing (CN)

(21) Appl. No.: 15/825,221

(22) Filed: Nov. 29, 2017

(51) Int. Cl. G06F 19/00; A61H 39/08; G06Q 50/22

(52) U.S. Cl. CPC G06F 19/345; G06Q 50/22; G06F 19/3481; A61H 39/08

(57) ABSTRACT

A method, system, and computer program product for determining and improving treatment points includes: configuring one or more treatment templates, the one or more treatment templates including service criteria and treatment points; receiving a treatment request from a computing device, the treatment request including an identification of a problem area of a user of the computing device; selecting a first treatment template from the one or more treatment templates based on the treatment request, the first treatment template including treatment points; transmitting the treatment points from the treatment template to the computing device; collecting patient treatment responses from the computing device; analyzing the treatment responses using natural language processing, image analysis, and learning modules; identifying adjusted treatment points based on the analysis; generating a second treatment template using the patient treatment responses and the adjusted treatment points.

### BACKGROUND

The present disclosure relates to cognitive assistants, and more specifically to using a cognitive assistant to determine treatment points.

Cognitive assistants are a form of artificial intelligence (AI) in which a machine displays cognitive functions that have previously been associated with humans. AI allows computers to learn, reason, problem solve, etc. A cognitive assistant may provide intelligence that assists a human in executing a task.

### SUMMARY

The present invention provides a computer-implemented method, system, and computer program product to determine and improve treatment points. The method may include configuring one or more treatment templates, the one or more treatment templates including service criteria and treatment points. The method may further include receiving a treatment request from a computing device, the treatment request including an identification of a problem area of a user of the computing device. The method may further include selecting a first treatment template from the one or more treatment templates based on the treatment request, the first treatment template including treatment points. The method may further include transmitting the treatment points from the treatment template to the computing device. The method may further include collecting patient treatment responses from the computing device, the treatment responses including at least one of biometric responses, treatment gestures, and treatment feedback. The method may further include analyzing the treatment responses using natural language processing, image analysis, and learning modules. The method may further include identifying adjusted treatment points based on the analysis. The method may further include generating a second treatment template using the patient treatment responses and the adjusted treatment points.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a flowchart of a set of operations for determining treatment points, according to various embodiments.

FIG. 2 depicts a flowchart of a set of operations for generating a treatment template, according to various embodiments.

FIG. 3 depicts a block diagram of an example computer system for determining and improving treatment points, according to various embodiments.

FIG. 4 depicts a block diagram of an example user device, according to various embodiments.

FIG. 5 depicts a block diagram of an example server, according to various embodiments.

FIG. 6 depicts a block diagram of a sample computer system for determining and improving treatment points, according to various embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present disclosure relates to cognitive assistants, and more specifically to using a cognitive assistant to determine treatment points. While the present disclosure is not necessarily limited to such applications, various aspects of the disclosure may be appreciated through a discussion of various examples using this context.

Acupuncture points, or acupoints, are locations on the body that are the focus of acupuncture, acupressure, sonopuncture, deep massage, cupping, scraping, and laser acupuncture treatment. Traditional Chinese medicine indicates that there are as many as two thousand acupuncture points on the human body, which are connected by 20 pathways (12 main, 8 secondary) called meridians. There are also numerous “extra points” not associated with a particular meridian. The pathways, meridians, and extra points make up a complex acupuncture system that is difficult to understand and master.

An acupuncturist is expected to remember these two thousand acupuncture points and their meridians, as well as the extra points. The acupuncturist is also expected to know when and where to rub those points to cure various issues. For example, there are 6 acupressure points for “quick constipation relief” and 12 acupressure points to “treat dizziness, fainting, and vertigo.” However, it takes a lot of time and practice to master the acupuncture points, pressures, and tricks. Additionally, each patient may be a different size (e.g., weight, height, etc.) which may result in each patient having slightly different locations of acupuncture points.

The present disclosure provides a computer-implemented method, system, and computer program product to determine and improve treatment points, such as acupuncture points. Treatment points may be a type, or a technique, of treatment and may also include the areas or locations on the body to apply or conduct the treatment. For example, a treatment point may be to insert a needle into acupoint St-9, which is an acupuncture point in the stomach meridian. In another example, a treatment point may be to apply cups, using cupping therapy methods, to a targeted area of a patient's body (e.g., acupoint St-9). The present disclosure can be used for any type of treatment points and is not limited to acupuncture. A cognitive assistant may be used to guide and assist patients or practitioners (e.g., acupuncturists, or other treatment specialists) to find an effective set of treatment (e.g., acupuncture) points for relieving pain or other symptoms in real time based on medical status and health history. The cognitive assistant may assist practitioners and may help determine more accurate treatment points and techniques. Additionally, the cognitive assistant may assist and instruct patients (i.e., a person with an issue to be treated) to safely self-treat their pain or other symptoms. A user, as referred to herein, may include practitioners, such as acupuncturists, and/or patients.

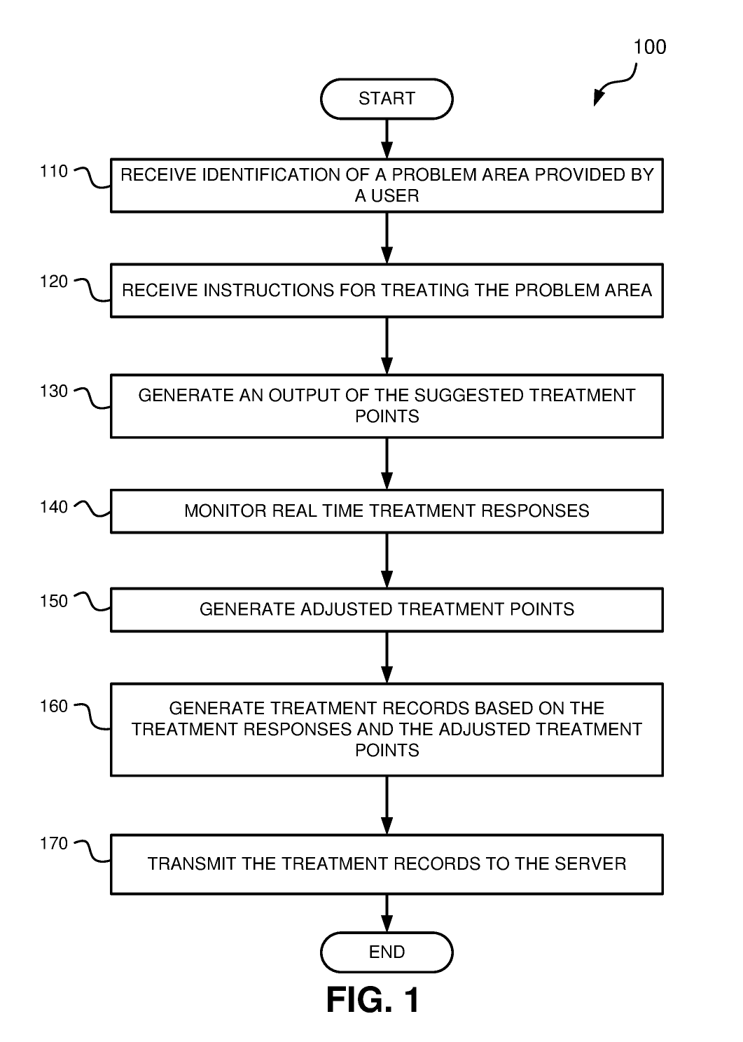

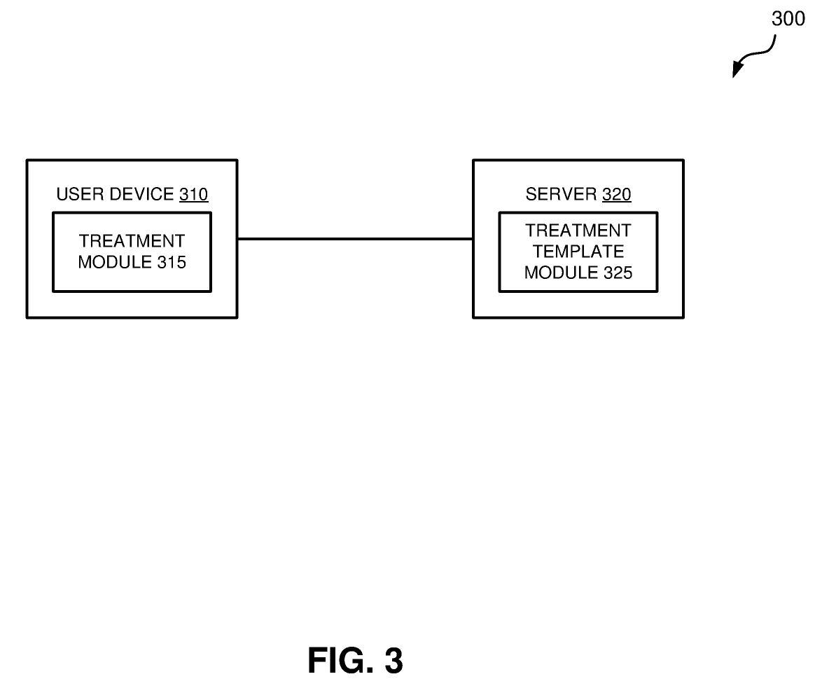

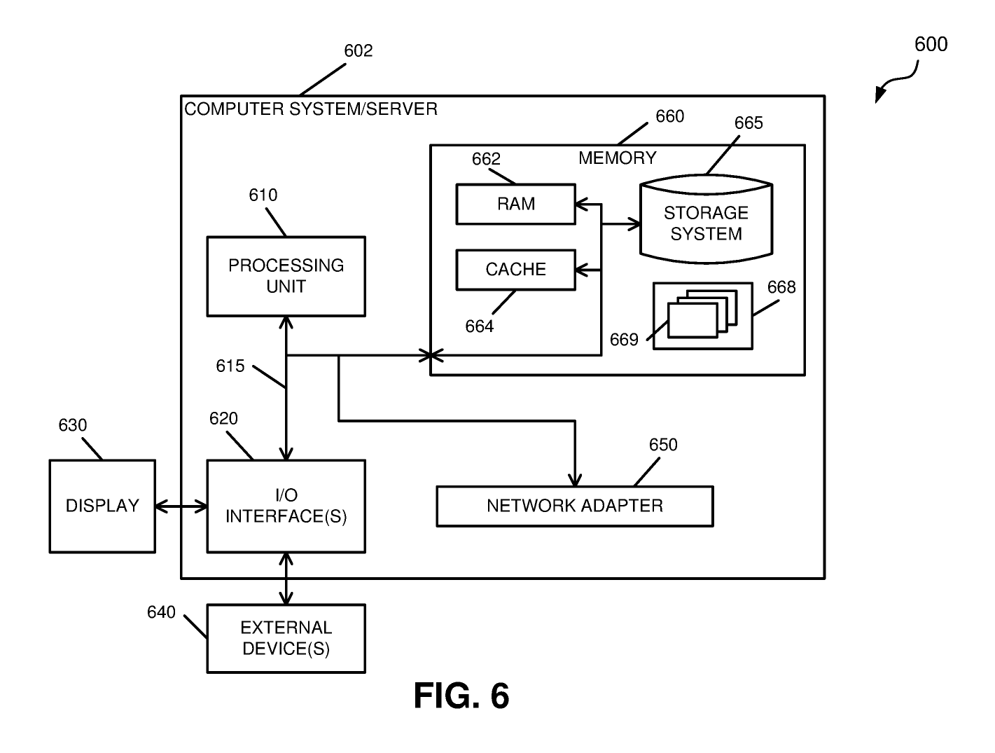

Referring now to FIG. 1, a flowchart illustrating a method 100 for determining treatment points is depicted, according to various embodiments. In an embodiment, the method 100 is implemented as a computer script or computer program (e.g., computer executable code) to be executed by a computer device, such as user device 310 (FIG. 3). The computer device, or user device, may be part of a computer system, such as computer system 300 (FIG. 3) or computer system 600 (FIG. 6). The computer device may correspond to a mobile app, web browser, etc., executed on a client-device, such as user device 310 (FIG. 3). In some embodiments, the computer device corresponds to an augmented reality device (e.g., head-mounted display (HMD), eyeglasses, handheld devices, computer, etc.).

In various embodiments, a computer device is configured to execute operation 110 to receive identification of a problem area provided by a user. The problem area may include an area on the body associated with a problem (e.g., back) and/or a symptom associated with a problem (e.g., migraine, sore back, etc.). The problem area provided by the user may be a problem area on a patient. In some embodiments, the patient is the user. The patient may self-treat in some instances. In other embodiments, a practitioner is the user, the practitioner treating the patient. The identification of a problem area provided by the user may be received as a string of characters. In some embodiments, the problem area is identified after user submission of the problem area. In various embodiments, the identification of the problem area provided by the user is received as an image (e.g., picture, video, graphics interchange format (GIF), etc.). In other embodiments, the identification of the problem area provided by the user is received as a data packet with both an image and a string of characters describing the image. In various embodiments, the user selects to take the image using the augmented reality device. The image may be transmitted to the computer device from the augmented reality device. In other embodiments, the computer device may be the augmented reality device, in which case the image is received by the computer device once the image is taken with the augmented reality device. In various embodiments, the identification of the problem area is received by a device, such as an augmented reality device, separate from the computer device, and is then transmitted to the computer device. Once the identification of the problem area is received by the computer device, the computer device may transmit, or send, the identification of the problem area to a server.

In various embodiments, a computer device is configured to execute operation 120 to receive instructions for treating the problem area. The instructions may be received from a server, such as server 320 (FIG. 3). The server may be part of a second computing device, or a centralized computer system for processing requests or instructions received from the computing device. The server, or a second computing device including the server, may be connected to the computing device. In some embodiments, the computing device may contain instructions for various treatments in a storage connected to the computing device. In those embodiments, rather than transmitting instructions to the computing device, the server may transmit a list of one or more treatments to the computing device. The computing device may be configured to receive that list of one or more treatments and to access the instructions for those one or more treatments from the connected storage.

In some embodiments, the instructions include at least suggested treatment points. Suggested treatment points may include suggested methods of treatment and locations of treatment. For example, if a patient has back pain, the suggested treatment points may be locations on the patient's back to apply pressure for a deep massage. In another example, a patient may be experiencing a sore neck and the suggested treatment points may include using the scraping technique on certain pathways, or meridians, of the patient. The instructions may be received in response to the computing device transmitting the identification of the problem area to the server and requesting instructions for treatment.

In some embodiments, the computer system is further configured to identify a user profile for the user with the problem area, in response to receiving the identification of the problem area. The user profile may include a treatment skill level of the user, where the treatment skill level indicates a competence of the user in executing treatments. For example, if the user is an acupuncturist trained in acupuncture, the treatment skill level may be high (e.g., 9/10, 90%, 0.9, etc.), indicating that the user, or acupuncturist, is highly competent in executing acupuncture treatments. In another example, the user may be a patient with no knowledge of acupuncture, with a very low skill level (e.g., 1/10, 10%, 0.1, etc.) indicating that the user, or patient, is minimally competent in executing acupuncture treatments. In various embodiments, the instructions for treating the problem area are at a skill level similar to, if not the same as, the skill level of the user. For example, when the treatment skill level is high, such as the skill level of an experienced acupuncturist, the instructions may include complex treatment suggestions and may use complex terminology known to trained acupuncturists. In another example, when the treatment skill level is low, such as the skill level of a patient with no acupuncture experience, the instructions may include simple treatment suggestions and may use simple terminology and imagery to help convey the treatment instructions.

In some embodiments, the user profile is analyzed to determine historical data of the user, the historical data including historical treatments. Historical treatments may be past instructions for treating a problem area and/or past suggested treatment points, for problems identified at a time before the current time. Analyzing the user profile may include scanning the user profile to determine past treatments for problem areas similar to the identified problem area. The historical data may be transmitted to the server to enable the server to generate the instructions for treating the problem area. In some embodiments, receiving instructions for treating the problem area is in response to transmitting the historical data to the server.

In various embodiments, a computer device is configured to execute operation 130 to generate an output of the suggested treatment points. Generating an output may include generating a display of the suggested treatment points. The display may include a layout of the instructions over the problem area. In some embodiments, generating a display of the suggested treatment points includes creating a diagram (e.g., schematic diagram, flow chart, table, etc.) to display the treatment points. Generating a display of the suggested treatment points may include displaying the treatment points on a picture, or diagram, of the human body. In some embodiments, when the identification of the problem area includes an image, the instructions for treating the problem area may be over the top of the image, resulting in easier comprehension by a user. The image may be the image sent to the server in operation 110. In some embodiments, using an augmented reality device, the treatment points are displayed over the problem area in real time, using augmented reality. In various embodiments, generating an output of the suggested treatment points includes generating an audio transmission, or audio instructions, of the suggested treatment points.

In various embodiments, a computer device is configured to execute operation 140 to monitor real time treatment responses of the user. Monitoring the real time treatment responses of the user may be done in response to generating the display of the suggested treatment points. In some embodiments, the treatment responses include biometric responses and/or treatment gestures and the suggested treatment points. The treatment responses may be monitored using biometric sensors connected to the computing device. The biometric sensors may be a part of wearable devices (e.g., Apple Watch®, Fitbit®, or any other wearable technology). In other embodiments, the biometric sensors are included in a kit, where the kit may connect to the computer device. In some embodiments, the treatment responses are monitored using an augmented reality device. The augmented reality device may include biometric sensors to monitor the responses. Treatment responses may include biometric data such as heart rate, body temperature, breathing rate, etc.

In various embodiments, monitoring treatment responses includes monitoring a real time image of the user (e.g., patient or practitioner). The image, or visual, of the user may allow for detection of user actions, such as flinching, shifting, rubbing, etc. that may indicate a pain of the user. In some embodiments, a separate device, such as a camera, is connected to the computer device to provide a real time image of the user. In other embodiments, an augmented reality device provides the real time image of the user.

In various embodiments, monitoring real time treatment responses includes receiving the biometric responses from biometric sensors, determining treatment gestures of the user, and generating a user treatment response based on the biometric responses and the treatment gestures. Treatment gestures may be gestures (e.g., or actions) included in the suggested treatment points, in order to treat the problem area. Examples of treatment gestures may include inserting a needle for acupuncture, rubbing and applying pressure for a deep massage, placing or applying cups for cupping, scraping using special tools, etc. In some embodiments, treatment gestures are determined using augmented reality devices or devices capable of monitoring a real time image of the user. The real time image may show the actions of the user (e.g., inserting a needle for acupuncture), and these actions may be the treatment gestures.

In some embodiments, the treatment responses (i.e., biometric responses and the treatment gestures) are analyzed to determine the biometric responses in response to the treatment gestures. In various embodiments, the user treatment response may be the biometric response to the treatment gestures. For example, a heartrate of a user may increase in response to inserting a needle into the body. The biometric responses, such as heartrate in this example, may be monitored before, during, and after the treatment gesture. In the example, the heartrate may increase during or immediately following the insertion of the needle. Once the needle is removed, the heartrate may decrease. Because the heartrate was increased during the execution of the treatment gesture, the increased heartrate may be the user response.

In various embodiments, a computer device is configured to execute operation 150 to generate adjusted treatment points based on the treatment responses. The adjusted treatment points may be generated by applying analytic analysis against the treatment responses. In some embodiments, there may be threshold levels for the real time treatment responses, such that when the treatment responses are greater than, or less than, the threshold levels, the adjusted treatment points are generated. For example, when a heartrate of a user increases in response to inserting a needle into the body during acupuncture, there may be a threshold heartrate level. If the heartrate of the user is greater than the threshold heartrate, an adjusted treatment point, or an adjusted acupuncture point is generated. The increased heartrate may occur in response to the treatment gesture (e.g., needle insertion). The threshold heartrate level may be a heartrate level that is determined to be in a normal, or average range, during an execution of the treatment response. Because the increased heartrate is greater than the threshold heartrate, the adjusted acupuncture point is a second treatment point designed to lower the heartrate. The adjusted treatment point may be a corrected treatment point to better treat the problem area. In some embodiments, the adjusted treatment point is a treatment point generated to alleviate patient duress, indicated by biometric responses, during the implementation of the treatment gesture. The analysis may be applied to the treatment responses to determine the adjusted treatment points to achieve optimum treatment responses.

In some embodiments, a sentiment is determined for the user treatment response. The sentiment may be determined by identifying sentiment threshold levels for the biometric responses and the treatment gestures. Sentiment may be determined using facial analysis, voice analysis and speech recognition, natural language processing, etc. In various embodiments, biometric responses, and/or treatment gestures, less than the sentiment threshold level indicate a negative sentiment. In other embodiments, biometric responses, and/or treatment gestures, greater than the sentiment threshold indicate a negative sentiment. Continuing the previous example, the increased heartrate in response to the needle insertion may be determined to be an indication of patient duress, which may be a negative response, or a negative sentiment towards the treatment point. Generating the adjusted treatment points may be in response to determining that the user treatment response is negative. A negative user treatment response may indicate that the suggested treatment points did not help the user.

In various embodiments, a computer device is configured to execute operation 160 to generate treatment records based on the treatment responses and the adjusted treatment points. The treatment records may indicate a result of the suggested treatment points. The treatment records may include suggested treatment points and the associated treatment gestures and/or biometric responses. In some embodiments, the treatment records may include adjusted treatment points and the treatment gestures and biometric responses associated with those adjusted treatment points. Generating the treatment records may include analyzing the real time treatment responses to determine an overall result of the suggested treatment points. The overall result of the suggested treatment points may be an overall sentiment, such as positive or negative. The overall result may include real time treatment responses for each treatment point and adjusted treatment point. In some embodiments, generating the treatment records includes receiving a string of characters submitted by the user as user feedback, which may include user opinions of the treatment points. The string of characters may be analyzed using natural language processing for semantic and syntactic content to determine a sentiment of the string of characters.

In various embodiments, a computer device is configured to execute operation 170 to transmit the treatment records to the server. Transmitting the treatment records to the server may enable the server to generate a treatment template of the user. The treatment template of the user may include user health data, the problem area provided by the user, the suggested treatment points, the adjusted treatment points, and the treatment records. In various embodiments, the treatment template of the user is used by the computing device to determine, or generate, future instructions (i.e., instructions in a time period subsequent to the current time period) for treating the problem area.

In an example, the computer device is an augmented reality device. In some instances, the augmented reality device may be worn by a user (e.g., patient and/or practitioner) throughout a treatment. The augmented reality device may receive identification of a problem area provided by a user by receiving, or processing, an augmented image, or video, taken by a user of the augmented reality device. The user may be a patient or a practitioner. The augmented reality device may transmit the identification of the problem area to a server, and may receive instructions for treating the problem area from the server. The augmented reality device may then generate a display of the suggested treatment points over an augmented image of the problem area. The display may also include instructions on how to treat the problem area. The augmented reality device may then monitor real time treatment responses of the user. In a case where the user is the patient, the real time treatment responses may be monitored using biometric sensors, either part of or connected to the augmented reality device. In a case where the user is the practitioner, the real time treatment responses may be monitored using the augmented reality device to gather images of the treatment and determine treatment gestures of the practitioner based on the images. The augmented reality device may generate adjusted treatment points and display the adjusted treatment points over the problem area as an augmented display. The augmented reality device may compile all treatment points and treatment responses to generate treatment records. These treatment records may be transmitted by the augmented reality device to the server.

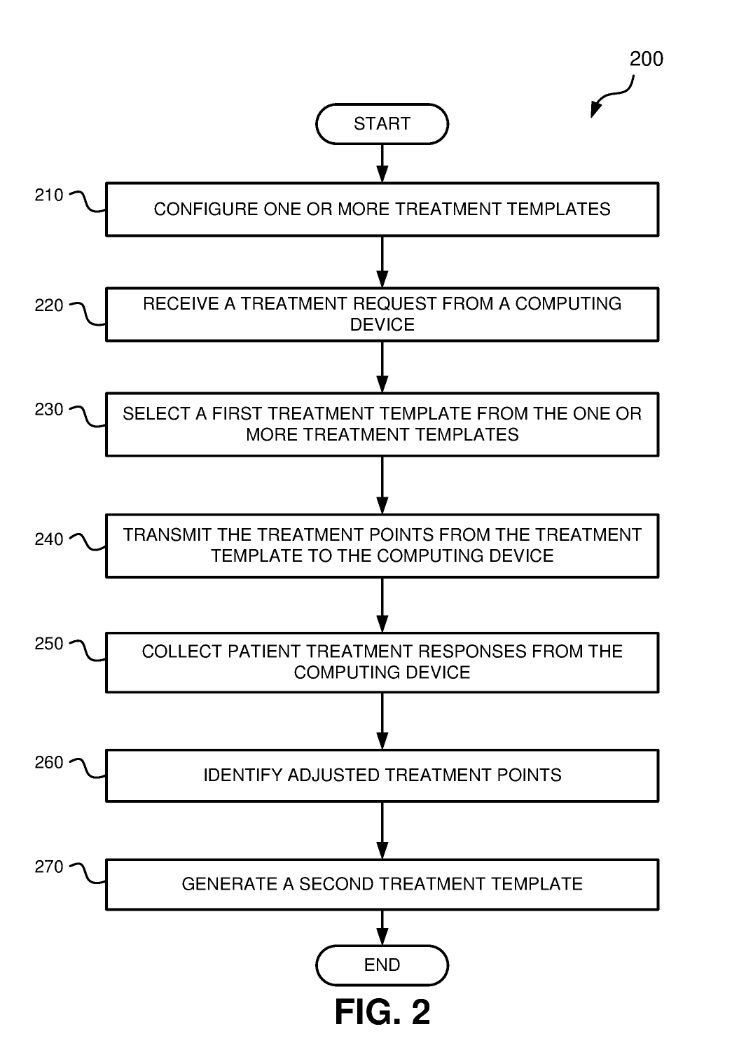

Referring to FIG. 2, a flowchart illustrating a method 200 for generating a treatment template is depicted, according to various embodiments. In an embodiment, the method 200 is implemented as a computer script or computer program (e.g., computer executable code) to be executed by a server, such as server 320 (FIG. 3), on, or connected to, a computer system, such as computer system 300 (FIG. 3) or computer system 600 (FIG. 6). In various embodiments, the server is a device, such as computer system/server 602.

In various embodiments, a server is configured to execute operation 210 to configure one or more treatment templates. Configuring the treatment templates may include organizing treatment templates based on historical treatment data (i.e., data of previous treatments) stored on the server. Historical treatment data may include historical treatment points, historical adjusted treatment points, historical treatment responses, etc. The one or more treatment templates may include service criteria and treatment points. Treatment points may be areas or spots to treat and/or a method of treatment. Acupuncture is one example method, or technique, of treating the treatment points. Service criteria may include symptoms, problem areas, and/or patient data (e.g., height, weight, gender, health data, etc.). Service criteria may also take the form of limit on the type of patient data or a range of a type of patient data to which a treatment point may apply. For example, service criteria for a treatment point, such as a symptom or a problem area (e.g., back pain) may include a height limitation (e.g., between 62 inches and 66 inches). Service criteria may include any criteria or limitations for the treatment points. Various users, particularly users with different heights and weights, may have different treatment points for the same problem area or symptom. Service criteria may result in more accurate treatment templates and treatment suggestions.

In various embodiments, a server is configured to execute operation 220 to receive a treatment request from a computing device. In some embodiments, the computing device is user device 310 (FIG. 3). The treatment request may include an identification of a problem area provided by a user of the computing device. As discussed herein, the treatment request may include an image, a string of characters, etc. The treatment request may further include patient data, the patient data including health history and physical data. In some embodiments, the received treatment request includes a treatment skill level of the user. In some embodiments, the user is an individual (e.g., acupuncturist) looking for assistance treating a patient. In other embodiments, the user is a patient looking for assistance for self-treatment. The treatment skill level may indicate a competence of the user in possible methods of treatment.

In various embodiments, a server is configured to execute operation 230 to select a first treatment template from the one or more treatment templates, based on the treatment request. The first treatment template may include treatment points. In some embodiments, treatment points include treatment instructions at the treatment skill level of the user.

In various embodiments, selecting the first treatment template includes identifying the problem area provided by the user and the patient data provided in the treatment request, and selecting the treatment template with treatment suggestions based on the health history and the physical data for the problem area. The treatment template may be selected using the treatment request and the patient data to determine a treatment template. The treatment template may have service criteria and treatment points that correlate with, or match, the treatment request and the patient data. For example, the treatment request may include an indication that the patient has a sore back. The patient may be a male who is 72 inches in height, as indicated by the patient data. A treatment template with treatment points for a sore back may be selected. In some instances, a treatment template with treatment points for a sore back for patients ranging from 65 inches-75 inches in height may be selected. In another example, a user may be seeking treatment for drowsiness. The user may be female, 62 inches tall, and 110 pounds. In this example, selecting the first template may include identifying that the problem area is drowsiness, and selecting a treatment template with treatment suggestions for drowsiness, the treatment suggestions for a person with physical traits (height, weight, etc.) similar to the user. In one example, there may be a template for drowsiness for a female ranging from 60-64 inches tall and between 100-120 pounds. There may be a second template for drowsiness for a male ranging from 60-64 inches tall and between 100-120 pounds. In another example, there may be a template for drowsiness for a female, with no other criteria. In various embodiments, a greater amount of accurate service criteria may result in more accurate treatment points.

Each treatment template may include treatment points for a problem area, the treatment points specific to health history and the physical data. In various embodiments, the one or more templates are categorized based on the problem area. For example, when the problem area is drowsiness, the templates with treatment suggestions for drowsiness may be categorized under drowsiness. Further, the templates within the drowsiness categorization may be categorized based on heath history and physical data, such as height, weight, gender, etc.

In various embodiments, selecting the first treatment template includes identifying a focus area of the problem area provided by the user, determining the one or more templates assigned to the identified focus area, and selecting the treatment template from the one or more templates assigned to the identified focus area based on historical treatment data (e.g., the health history and the physical data from the problem area). The focus area of the problem area may be categorized by a specific problem area (e.g., migraines), a body location of the problem area (e.g., back, leg, shoulder, etc.), a symptom of the problem area (e.g., head pain, back pain, indigestion, etc.), or any other ways to categorize the problem area.

In various embodiments, a server is configured to execute operation 240 to transmit the treatment points from the selected treatment template to the computing device. The treatment points may include visual and audio instructions to treat the problem area. In some embodiments, the treatment points may be transmitted via any suitable network (e.g., local area network, wide area network, cloud computing, Internet of Things, etc.).

In various embodiments, a server is configured to execute operation 250 to collect patient treatment responses from the computing device. The treatment responses may include biometric responses, treatment gestures, and treatment records. Treatment records may include user feedback regarding the treatment points. This user feedback may be inputted by a user to the computing device. The treatment responses may be analyzed using methods such as natural language processing, image analysis, and/or learning modules to identify adjusted treatment points.

In various embodiments, a server is configured to execute operation 260 to identify adjusted treatment points. The analysis (such as natural language processing, image analysis, and/or learning modules) may be used to identify adjusted treatment points. Identifying adjusted treatment points may include determining a sentiment (e.g., positive or negative) of the patient treatment response. When it is determined that the patient treatment response has a negative sentiment, indicating that the response is negative, additional patient treatment responses may be collected (e.g., additional biometric responses). The additional patient treatment responses may then be analyzed to determine a second sentiment for the additional treatment responses. When it is determined that the additional patient treatment responses are positive, the treatment points that resulted in the positive sentiment points may be adjusted treatment gestures, where the adjusted treatment gestures are adjusted treatment points. If it is determined that the additional patient treatment responses are negative, additional patient treatment responses may again be collected. In some embodiments, the server receives biometric data, and in some cases real time imagery, from a computing device. The biometric data and imagery may be used when determining the adjusted treatment points.

In various embodiments, a server is configured to execute operation 270 to generate a second treatment template. The patient treatment responses and the adjusted treatment points may be used to generate the second treatment template. In some embodiments, the second treatment template is added to the first treatment template. Generating a second treatment template using the patient treatment responses may include determining the adjusted treatment points of the problem area. These may be determined using patient treatment responses and patient feedback. For example, patient feedback may be analyzed to determine a sentiment towards the adjusted treatment point. Patient treatment responses that express a positive sentiment towards the adjusted treatment point may indicate that the adjusted treatment points are treatment points of the problem area. The new template, then, may indicate that the adjusted treatment points are a treatment of the problem area. In some embodiments, patient feedback includes a string of characters indicating whether the adjusted treatment points treated the problem area.

In some embodiments, generating a second treatment template includes altering (i.e., adding additional information or data) to the first treatment template. The additional information may include the adjusted treatment points, or an adjusted treatment area. In some embodiments, the second treatment template is a customized treatment template for the patient.

Referring to FIG. 3, a block diagram of an example computer system 300 for determining and improving treatment points is depicted, according to various embodiments. System 300 is one possible computer system capable of determining and improving treatment points, and is illustrated for example purposes.

In various embodiments, system 300 includes a user device 310 and a server 320. In some embodiments, the user device 310 communicates with the server 320 via any suitable network (e.g., local area network, wide area network, etc.), cloud computing, or through the Internet of Things. The user device 310 may include treatment module 315. In some embodiments, treatment module 315 is an application or is accessed through a web browser on the user device 310. In other embodiments, treatment module 315 is software downloaded on the user device 310. Treatment module 315 may execute the method 100 (FIG. 1). The server 320 may include a treatment template module 325. In some embodiments, server 320 is part of a cognitive assistant, such as IBM Watson Health™. Treatment template module 325 may execute the method 200 (FIG. 2).

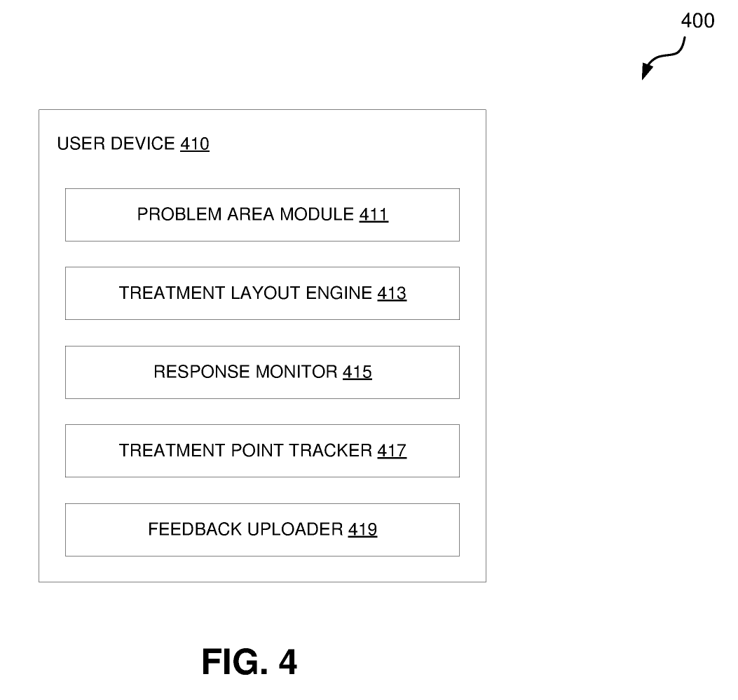

Referring to FIG. 4, a block diagram 400 of an example user device 410 is depicted, according to various embodiments. In some embodiments, user device 410 is user device 310 (FIG. 3). User device 410 may include a problem area module 411, a treatment layout engine 413, a response monitor 415, a treatment point tracker 417, and a feedback uploader 419. Problem area module 411, treatment layout engine 413, response monitor 415, treatment point tracker 417, and feedback uploader 419 may be included in a treatment module, such as treatment module 315 (FIG. 3). In some embodiments, problem area module 411 may receive identification of a problem area and receive instructions for treating the problem area (e.g., operation 110 and operation 120 (FIG. 1)). The treatment layout engine may generate an output of the suggested treatment points (e.g., operation 130 (FIG. 1)) and response monitor 415 may monitor real time treatment responses (e.g., operation 140 (FIG. 1)). Treatment point tracker 417 may generate adjusted treatment points and generate treatment records (e.g., operation 150 and operation 160 (FIG. 1)), and feedback uploader 419 may transmit the treatment records to the server (e.g., operation 170 (FIG. 1)).

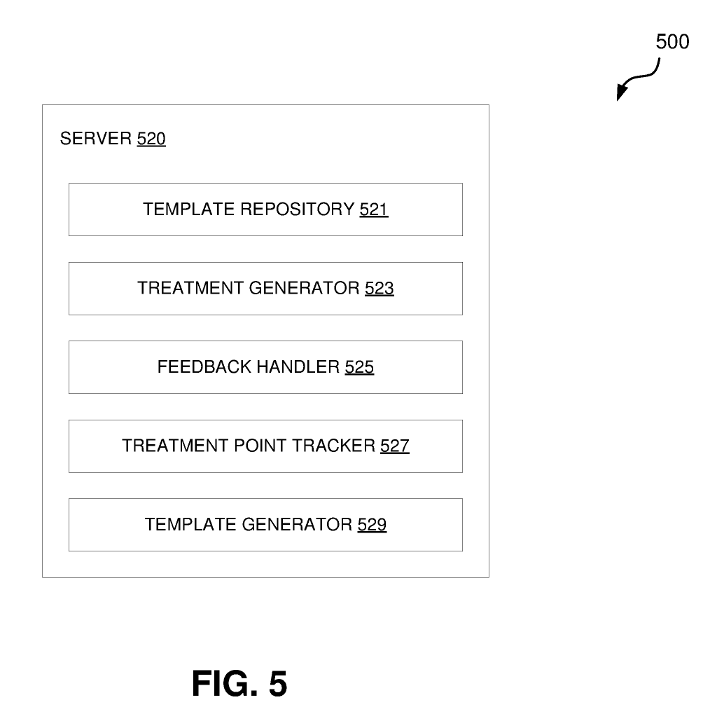

Referring to FIG. 5, a block diagram 500 of an example server 520 is depicted, according to various embodiments. In some embodiments, server 520 is server 320 (FIG. 3). Server 520 may include a template repository 521, a treatment generator 523, a feedback handler 525, a treatment point tracker 527, and a template generator 529. In various embodiments, template repository 521, treatment generator 523, feedback handler 525, treatment point tracker 527, and template generator 529 are included in a treatment template module, such as treatment template module 325. In some embodiments, template repository 521 stores templates and may execute operation 210 (FIG. 2). Treatment generator may receive a treatment request from a computing device (e.g., operation 220 (FIG. 2)), elect a first treatment template from the one or more treatment templates (e.g., operation 230 (FIG. 2)), and transmit the treatment points from the selected treatment template to the computing device (e.g., operation 240 (FIG. 2)). The treatment template may be selected from the template repository 521. Collecting patient treatment responses from the computing device (e.g., operation 250 (FIG. 2)) may be executed by the feedback handler 525, identifying adjusted treatment points (e.g., operation 260 (FIG. 2)) may be executed by the treatment point tracker 527, and generating a second treatment template (e.g., operation 270 (FIG. 2)) may be executed by the template generator 529. In various embodiments, the generated second treatment template is then stored in the template repository 521.

Referring to FIG. 6, computer system 600 is a computer system/server 602 is shown in the form of a general-purpose computing device, according to various embodiments. The components of computer system/server 602 may include, but are not limited to, one or more processors or processing units 610, a system memory 660, and a bus 615 that couple various system components including system memory 660 to processor 610.

Bus 615 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media.

System memory 660 can include computer system readable media in the form of volatile memory, such as random access memory (RAM) 662 and/or cache memory 664. Computer system/server 602 may further include other removable/non-removable, volatile/non-volatile computer system storage media. By way of example only, storage system 665 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 615 by one or more data media interfaces. As will be further depicted and described below, memory 660 may include at least one program product having a set (e.g., at least one) of program modules that are configured to carry out the functions of embodiments of the invention.

Program/utility 668, having a set (at least one) of program modules 669, may be stored in memory 660 by way of example, and not limitation, as well as an operating system, one or more application programs, other program modules, and program data. Each of the operating system, one or more application programs, other program modules, and program data or some combination thereof, may include an implementation of a networking environment. Program modules 669 generally carry out the functions and/or methodologies of embodiments of the invention as described herein.

Computer system/server 602 may also communicate with one or more external devices 640 such as a keyboard, a pointing device, a display 630, etc.; one or more devices that enable a user to interact with computer system/server 602; and/or any devices (e.g., network card, modem, etc.) that enable computer system/server 602 to communicate with one or more other computing devices. Such communication can occur via Input/Output (I/O) interfaces 620. Still yet, computer system/server 602 can communicate with one or more networks such as a local area network (LAN), a general wide area network (WAN), and/or a public network (e.g., the Internet) via network adapter 650. As depicted, network adapter 650 communicates with the other components of computer system/server 602 via bus 615. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electronic signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object orientated program language such as Smalltalk, C++, or the like, and procedural programming languages, such as the “C” programming language or similar programming languages. The computer readable program instructions may execute entirely one the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
configuring one or more treatment templates, the one or more treatment templates comprising service criteria and treatment points;
receiving a treatment request from a computing device, the treatment request comprising an identification of a problem area of a user of the computing device;
selecting a first treatment template from the one or more treatment templates based on the treatment request, the first treatment template including treatment points;
transmitting the treatment points from the treatment template to the computing device;
collecting patient treatment responses from the computing device, the treatment responses comprising at least one of biometric responses, treatment gestures, and treatment feedback;
analyzing the treatment responses using natural language processing, image analysis, and learning modules;
identifying adjusted treatment points based on the analysis; and
generating a second treatment template using the patient treatment responses and the adjusted treatment points.

2. The method of claim 1, wherein the treatment request further comprises user data, the user data including health history and physical data.

3. The method of claim 2, wherein selecting the first treatment template comprises:
identifying the problem area of the user and the user data of the user from the treatment request; and
selecting the treatment template with treatment suggestions based on the health history and the physical data for the problem area.

4. The method of claim 2, wherein configuring the one or more treatment templates comprises:
generating one or more treatment templates based on the health history and the physical data, wherein each treatment template includes treatment points for a problem area, the treatment points specific to the health history and the physical data; and
categorizing the one or more templates based on the problem area.

5. The method of claim 4, wherein selecting the first treatment template comprises:
identifying a category of the problem area of the user;
determining the one or more templates assigned to the identified category; and
selecting the treatment template from the one or more templates assigned to the identified category based on the health history and the physical data for the problem area.

6. The method of claim 1, wherein the treatment points include at least one of visual and audio instructions to treat the problem area.

7. The method of claim 1, wherein identifying adjusted treatment points comprises:
analyzing the patient treatment responses to determine whether the patient treatment response is positive or negative;
in response to determining that the patient treatment response is a negative response, collecting additional patient treatment responses;
analyzing the additional patient treatment responses to determine whether the additional patient treatment response is positive or negative; and
in response to determining that the additional patient treatment responses are positive, determining adjusted treatment gestures, wherein the adjusted treatment gestures are adjusted treatment points.

8. The method of claim 1, wherein the treatment feedback includes user feedback of the treatment points, wherein user feedback is feedback inputted by a user to the computing device.

9. The method of claim 1, wherein generating the second treatment template using the patient treatment responses comprises:
determining that the adjusted treatment points are treatment points of the problem area; and
generating a treatment template with the adjusted treatment points.

10. The method of claim 9, wherein the second treatment template is a customized treatment template for the user.

11. The method of claim 1, wherein the received treatment request includes a treatment skill level of the user, the treatment skill level indicating a competence of the user in executing possible methods of treatment.

12. The method of claim 11, wherein the treatment points comprise treatment instructions at the treatment skill level of the user.

13. A system having one or more computer processors, the system configured to:
configure one or more treatment templates, the one or more treatment templates comprising service criteria and treatment points;
receive a treatment request from a computing device, the treatment request comprising an identification of a problem area of a user of the computing device;
select a first treatment template from the one or more treatment templates based on the treatment request, the first treatment template including treatment points;
transmit the treatment points from the treatment template to the computing device;
collect patient treatment responses from the computing device, the treatment responses comprising at least one of biometric responses, treatment gestures, and treatment feedback;
analyze the treatment responses using natural language processing, image analysis, and learning modules;
identify adjusted treatment points based on the analysis; and
generate a second treatment template using the patient treatment responses and the adjusted treatment points.

14. The system of claim 13, wherein the treatment request further comprises user data, the user data including health history and physical data.

15. The system of claim 14, wherein selecting the first treatment template comprises:
identifying the problem area of the user and the user data of the user from the treatment request; and
selecting the treatment template with treatment suggestions based on the health history and the physical data for the problem area.

16. The system of claim 14, wherein configuring the one or more treatment templates comprises:
generating one or more treatment templates based on the health history and the physical data, wherein each treatment template includes treatment points for a problem area, the treatment points specific to the health history and the physical data; and
categorizing the one or more templates based on the problem area.

17. The system of claim 13, wherein identifying adjusted treatment points comprises:
analyzing the patient treatment responses to determine whether the patient treatment response is positive or negative;
in response to determining that the patient treatment response is a negative response, collecting additional patient treatment responses;
analyzing the additional patient treatment responses to determine whether the additional patient treatment response is positive or negative; and
in response to determining that the additional patient treatment responses are positive, determining adjusted treatment gestures, wherein the adjusted treatment gestures are adjusted treatment points.

18. A computer program product comprising a non-transitory computer readable storage medium having program instructions embodied therewith, the program instructions executable by a server to cause the server to perform a method, the method comprising:
configuring one or more treatment templates, the one or more treatment templates comprising service criteria and treatment points;
receiving a treatment request from a computing device, the treatment request comprising an identification of a problem area of a user of the computing device;
selecting a first treatment template from the one or more treatment templates based on the treatment request, the first treatment template including treatment points;
transmitting the treatment points from the treatment template to the computing device;
collecting patient treatment responses from the computing device, the treatment responses comprising at least one of biometric responses, treatment gestures, and treatment feedback;
analyzing the treatment responses using natural language processing, image analysis, and learning modules;
identifying adjusted treatment points based on the analysis; and
generating a second treatment template using the patient treatment responses and the adjusted treatment points.

19. The computer program product of claim 18, wherein the treatment request further comprises user data, the user data including health history and physical data.

20. The computer program product of claim 19, wherein selecting the first treatment template comprises:
identifying the problem area of the user and the user data of the user from the treatment request; and
selecting the treatment template with treatment suggestions based on the health history and the physical data for the problem area.
